(19) United States
(12) Patent Application Publication
(10) Pub. No.: US 2009/0155735 A1
(43) Pub. Date: Jun. 18, 2009

(54) DENTAL TREATMENT OR EXAMINATION APPARATUS

(75) Inventor: Christoph Hauger, Aalen (DE)

Correspondence Address: CASELLA & HESPOS, 274 MADISON AVENUE, NEW YORK, NY, 10016, US

(73) Assignee: CARL ZEISS SURGICAL GMBH, Oberkochen (DE)

(21) Appl. No.: 12/335,579

(22) Filed: Dec. 16, 2008

(30) Foreign Application Priority Data
Dec. 18, 2007 (DE) 10 2007 063 419.8

(51) Int. Cl. A61C 3/00

(52) U.S. Cl. 433/29

(57) ABSTRACT

A dental apparatus uses a white light interferometer (7) and has an emitter (31) for emitting measurement radiation toward a tooth, a receiver (31) for receiving measurement radiation reflected by the tooth, superposition equipment (21) for superposing reference radiation and reflected measurement radiation, and a detector (23) for detecting the superposed radiation and generating an interferometric signal representing the superposed radiation. The emitter (31) and receiver (31) are in the distal end (5) of a dental instrument (1) that can be brought close to the tooth. A control unit (13) causes the white light interferometer (7) to carry out depth scans of the tooth. An analyzer (9) receives the interferometric signal from the detector (23) and determines a distance to the pulp of the tooth from its surface. A warning device (11) is connected to the analyzer (9) and emits a signal when the distance reaches a predetermined minimum distance.

### BACKGROUND OF THE INVENTION

1. Field of the Invention

The invention relates to a dental treatment or examination apparatus with a dental treatment or examination instrument. Additionally, the invention relates to a method for controlling a dental treatment or examination instrument and a method for monitoring a dental treatment or examination instrument.

2. Description of the Related Art

A tooth is essentially composed of three components, specifically the dentin; the enamel that coats the dentin for the latter's protection; and the pulp, also called dental pulp or, colloquially, the dental nerve that comprises the nerve fibers and blood vessels of the tooth. The pulp can be subdivided into the coronal pulp, which is found in the crown, and the radicular pulp, found in the root. The pulp tissue is particularly sensitive to thermal stimuli. Temperatures above 42° C. can thermally damage the pulp tissue, and this can lead to the pulp tissue dying off.

Information relating to the size and extent of the coronal pulp is of interest when preparing teeth so as to avoid inadvertent opening of the coronal pulp during the preparation of a tooth. Radiological display methods often are used to determine the extent of the pulp. However, the actual dimensions of the pulp often are reproduced incorrectly in radiological displays such as bitewing radiographs. It is possible for the extent of the pulp to be underestimated, particularly in the region of the molars.

DE 10 2005 044 889 A1 discloses a dental examination and/or treatment tool that comprises a lumen in which an imaging catheter is arranged for recording image data of an examination and/or treatment region. The imaging catheter is used for recording image data after a partial pulp removal in the root canal. In particular, the imaging catheter can be an OCT catheter for carrying out optical coherence tomography.

Dental diagnosis equipment with an optical camera and OCT equipment is known from the Patent Abstracts of Japan 2004344260A. The optical camera records a surface image of a tooth region in which a scan then is recorded by the OCT equipment.

It is not the object of either DE 10 2005 044 889 A1 or the Patent Abstracts of Japan to avoid inadvertent opening of the pulp. In particular in DE 10 2005 044 889 A1, the opening of the pulp is intended.

Therefore, there is the need for dental treatment and examination apparatuses that help avoid inadvertent opening of the pulp. Furthermore, there is the need for methods to control and monitor such equipment, which methods contribute to avoiding the inadvertent opening of the dental pulp.

It is therefore an object of the invention to provide a dental treatment or examination apparatus that helps avoid inadvertent opening of the dental pulp. It is another object of the invention to provide a method for controlling a dental treatment or examination instrument, which method contributes to avoiding the inadvertent opening of the dental pulp. It is a third object of the invention to provide a method for monitoring a dental treatment or examination instrument, which method contributes to avoiding inadvertent opening of the dental pulp.

### SUMMARY OF THE INVENTION

A dental treatment or examination apparatus according to the invention comprises a dental treatment or examination instrument, a white light interferometer, a control unit, an analysis device and a warning and/or stopping device that is designed to emit a warning signal and/or stop the dental treatment or examination instrument. The white light interferometer comprises a measurement beam branch, a reference beam branch, an emitter for emitting measurement radiation in the direction of a tooth to be treated or examined, a receiver for receiving measurement radiation reflected by the tooth to be treated or examined, superposition equipment for superposing reference radiation and reflected measurement radiation, and a detector for detecting the superposed radiation and for generating an interferometric signal representing the superposed radiation. The dental treatment or examination instrument has a distal end in which the emitter and the receiver are arranged and is designed to be brought close to the tooth of a patient to be treated or examined. In particular, the emitter and the receiver of the dental treatment or examination instrument can be identical. The control unit is assigned to the white light interferometer and comprises a control program that causes the white light interferometer to carry out depth scans of the treatment or examination object. The control program can cause such depth scans to be carried out continually, or only in the presence of an actuating signal. The depth scans sometimes also are referred to as A-scans. The analysis device is connected to the detector of the white light interferometer for receiving the interferometric signal. It is designed to determine the distance of the pulp of the tooth to be treated or examined from its current surface and output a distance signal representing the distance. The current surface of the tooth can either be the actual surface of the tooth or the surface of a tooth opening, such as a bore. The warning and/or stopping device is connected to the analysis device for receiving the distance signal and is designed to emit a warning signal and/or stop the dental treatment or examination instrument when the distance reaches or falls below a predetermined minimum distance. In particular, the dental treatment or examination apparatus according to the invention can also be designed as an examination apparatus that only comprises a white light interferometric probe as a dental examination instrument.

The apparatus of the invention makes it possible to examine a depth region in the tooth using white light interferometry, without the tooth having to be opened for this purpose. In particular, the depth scan makes it possible to easily determine the boundary between the dentin and the softer pulp, and the distance of this boundary from the current surface. For this purpose, a depth scan with a depth range of 1 to 3 mm generally suffices. Hence, the depth of the pulp below the surface of the tooth or the area of a tooth opening can be determined by an external examination. A warning signal is emitted if it is determined in the process that a predetermined minimum distance between the surface and the pulp is reached. The warning signal alerts the dental treatment staff to the fact that the predetermined minimum distance between the surface and the pulp has been reached. It is also possible to stop the treatment apparatus when the minimum distance is reached if the emitter and detector of the white light interferometer are integrated in a dental treatment apparatus, for example a dental drill. In the case of the drill, this would mean that the drill is switched off as soon as the distance reaches or falls below the minimum distance. Inadvertent opening of the pulp can be avoided to a large extent by means of the warning signal or by switching off the treatment instrument. It is also possible for the treatment staff to carry out the treatment with increased care when approaching the pulp after the warning signal has been emitted so that the inadvertent opening of the pulp is avoided in the case where the distance must fall below the minimum distance for medical reasons.

The measurement beam branch of the dental treatment or examination apparatus according to the invention may comprise an optical fiber with a distal fiber end arranged in the distal end of the dental treatment or examination instrument. The emitter and receiver can be formed by the distal fiber end. This affords the possibility of implementing the measurement beam branch with very small dimensions in the region of the dental treatment or examination device so that the emitter and the detector can be guided very close to the surface of the tooth, and in particular very close to the surface of even a small bore in the tooth. Furthermore, small fiber diameters afford the possibility of illuminating a surface region with a very small lateral extent. Thus, a very high lateral resolution can be obtained by the depth scan, which is particularly advantageous if a lateral scan also is intended to be carried out to determine the lateral course of the boundary between pulp and dentin.

The dental treatment instrument can be a drill with a drill tool having a distal drill tool end, with the distal fiber end being arranged in the distal drill tool end or in its vicinity. There is the risk of inadvertently opening the pulp when preparing a tooth by means of a drill. Hence, the apparatus of the invention can be used with particular advantage in a dental treatment instrument that has a drill to avoid inadvertently opening the pulp. In this case, the optical fiber can be arranged in the rotational axis of the drill tool of the drill so that the center of the current surface of the bore is always measured by the depth scan in a simple fashion. Alternatively, the optical fiber can be arranged outside of the drill tool such that the distal fiber end illuminates that location at which the distal drill tool end is located. In that case it is not necessary to arrange the fiber end in a rotating drill tool.

The control unit of the dental treatment or examination apparatus according to the invention can be provided with a control program that causes the white light interferometer to carry out depth scans of the treatment or examination object continually. This ensures that the distance of the surface to the pulp is monitored continually. The warning signal or stop signal then can be emitted as soon as the minimum distance is reached. Alternatively, it is possible that the dental treatment or examination apparatus comprises an actuating element to be operated by the treatment or examination staff. The actuating element is connected to the control unit that emits an actuating signal for actuating a depth scan. By way of example, the actuating element can be a button on the handpiece, a foot switch, et cetera. In this refinement, a depth scan is carried out only when required. This refinement is expedient in particular when the dental treatment and examination apparatus only comprises a white light interferometric probe as the sole examination instrument.

A lateral course of the boundary between the pulp and the dentin can be determined by providing the measurement beam branch of the white light interferometer with a scan apparatus that laterally offsets the surface area irradiated by the measurement radiation on the tooth to be treated or examined. Hence, it is possible to undertake a lateral scan (a so-called B-scan), which leads to one depth scan being carried out in each case at a number of points of a lateral region. This makes it possible to determine the course of the pulp over a relatively large surface area. In particular, this also makes it possible to emit the warning signal or the stop signal when the distance in a region that does not correspond to the current treatment region, but lies in its direct vicinity, has fallen below the minimum distance.

In a first method according to the invention for controlling a dental treatment instrument, a depth scan of the treated or examined tooth region is undertaken during the dental treatment by means of a white light interferometry method. The distance of the surface of the treated tooth region from the pulp of the tooth then is determined from the depth scan. The dental treatment instrument is stopped if the distance reaches or falls below a predetermined minimum distance. In this fashion it is possible to avoid unintended opening of the pulp by stopping the treatment instrument in good time by means of a white light interferometric measurement of the distance of the pulp from the surface.

In a second method according to the invention, a dental treatment or examination instrument is monitored by means of a depth scan of the treated or examined tooth region being undertaken during the dental treatment or dental examination by means of a white light interferometry method. The distance of the surface of the treated or examined tooth region from the pulp of the tooth then is determined from the depth scan. A warning signal is emitted if the distance reaches or falls below a predetermined minimum distance. In the process, the warning signal can prompt the examination staff to end the treatment or examination or, should this not yet be possible, to continue with increased care.

A lateral scan of the treated or examined tooth region can be carried out in both methods in addition to the depth scan so as to also be able to determine the distance of the pulp from the surface in regions that are adjacent to the current treatment or examination region. A depth scan then can be undertaken at every lateral point.

A depth scan can be carried out continually or only after the treatment or examination staff actuate an actuating apparatus (such as a button on the handpiece, a foot switch, et cetera), independently of whether a lateral scan is carried out or not. Continually carrying out depth scans lends itself to those cases where action has to be taken as soon as the minimum distance is reached. If reaching the minimum distance does not mark a critical boundary, but only serves to inform the treatment or examination staff, it can suffice to carry out a depth scan only on occasions initiated by the staff.

In both methods according to the invention, the depth scans can be carried out to a depth of 1 to 3 mm, starting from the surface. This depth is generally sufficient to avoid the inadvertent opening of the pulp.

Further features, characteristics and advantages of the invention emerge from the following description of exemplary embodiments, with reference being made to the attached figures.

### BRIEF DESCRIPTION OF THE DRAWINGS

FIG. 1 schematically shows a dental treatment or examination apparatus in the form of a block diagram.

FIG. 2 shows an embodiment of the apparatus in accordance with FIG. 1, in which an emitter and a receiver are integrated in a dental drill.

FIG. 3 shows a modification of the embodiment in accordance with FIG. 2.

FIG. 4 shows a further modification of the embodiment in accordance with FIG. 1.

FIG. 5 shows an embodiment of the apparatus in accordance with FIG. 1, in which the emitter and the receiver are integrated in a dental examination probe.

### DETAILED DESCRIPTION OF THE PREFERRED EMBODIMENTS

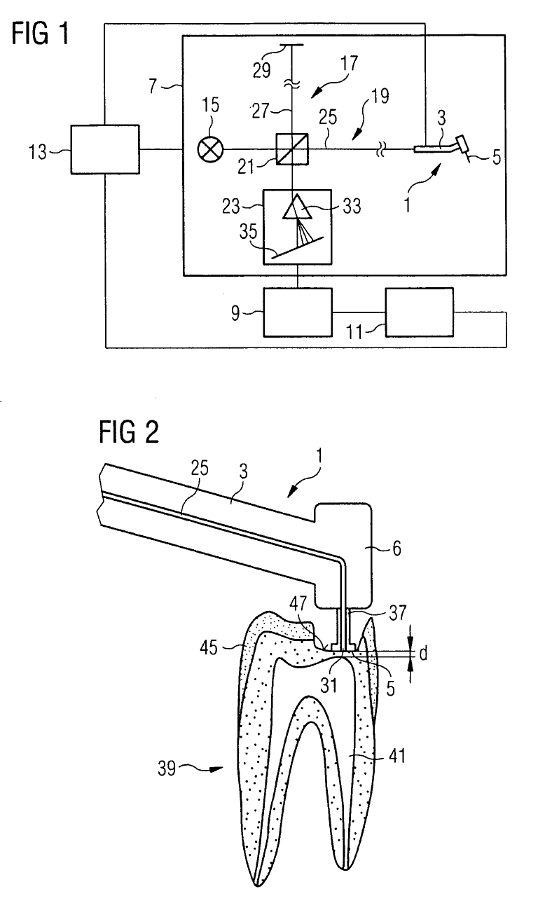

A dental treatment or examination apparatus according to the invention will be described in the following text with reference to FIG. 1. The apparatus comprises a dental treatment or examination instrument 1, which has a handpiece 3 and a distal end 5, and which in the present exemplary embodiment is illustrated in form of a dental drill. It furthermore comprises a white light interferometer 7, an analysis device 9, a warning or stopping device 11, and a control unit 13. The analysis device 9 and the control unit 13 are connected to the white light interferometer for receiving the interferometric signal or emitting control signals.

The white light interferometer comprises a broadband light source 15 which has a short to very short coherence length. The light emitted by the light source will be referred to as white light in the following text even though the broadband spectrum of the light does not necessarily have to result in white light. It is only significant that it is a broadband light source because the temporal coherence of the light reduces with increasing bandwidth. The white light interferometer 7 also comprises a reference beam branch 17, and a measurement beam branch 19, a splitter and superposition equipment 21 (which in the present exemplary embodiment is illustrated as a beam splitter), and a detector 23.

In the white light interferometer 7, the white light emitted by the broadband light source 15 is divided into a reference beam and a measurement beam by the beam splitter 21, the beams being respectively coupled into the reference beam branch 17 and the measurement beam branch 19. The two branches each comprise an optical waveguide 25 or 27, into which the reference light and measurement light are respectively coupled. In the reference branch, the measurement light is guided to a reflector 29 and from there it is guided back to the beam splitter 21 through the optical waveguide 27. The measurement light is guided in a similar fashion through the optical waveguide 25 to the distal end 5 of the dental treatment or examination instrument 1, where it is emitted from the distal fiber end 31 (not illustrated in FIG. 1, cf. FIG. 2). Measurement radiation is then reflected from the boundary between the pulp and the dentin in the tooth, and part of the reflected measurement radiation returns back through the distal fiber end 31 into the optical fiber 25 of the measurement beam branch 19. Thus, the distal fiber end 31 simultaneously serves as emitter and receiver of measurement radiation and reflected measurement radiation. The reflected measurement light is guided through the optical fiber to the beam splitter 21. There the measurement light is superposed on the reference light, and the superposition of measurement light and reference light is guided to the detector 23. In the present exemplary embodiment, said detector 23 comprises a spectroscope 33, illustrated in the figure as a prism, and a row of detectors 35, which detects the spectrum generated by the spectroscope 33 and converts it into an interferometric signal representing the spectrum.

So that it is even possible for interference effects to occur in the superposition of measurement light and reference light due to the short coherence length present, the lengths of the reference branch 17 and the measurement branch 19 are adjusted with respect to one another in such a fashion that the path difference between the measurement light and the reference light is smaller than the coherence length of the white light. An intensity maximum for a particular wavelength can only occur if the path lengths traversed by the reference light and the measurement light are equal. The intensity decreases with increasing difference in the traversed path length. Hence the depth at which the reflection took place can be inferred from the spectral intensity distribution.

Even though in the present example the depth at which the reflection occurs is determined from the spectral distribution of the superposed light, it is also possible to determine the depth without spectral splitting of the superposed light. In that case, an apparatus would be present by means of which the length of the reference beam branch or measurement beam branch can be adjusted. The depth at which the reflection occurs can likewise be inferred from the adjustment settings at which a maximum occurs in the superposed light.

Concrete embodiments of white light interferometers are described, for example, in DE 199 29 406 A1 or EP 1 314 953 A2. Reference is made to these documents with regard to a possible concrete embodiment of the white light interferometer of the dental treatment or examination apparatus according to the invention.

An interferometric signal is emitted by the detector 23 and in the current example it represents the spectral intensity distribution of the superposition of measurement light and reference light. This interference signal is received and evaluated by the analysis device 9, which is connected to the white light interferometer for receiving the interferometric signal. In the present case, the evaluation in essence comprises a Fourier transform of the spectral intensity distribution, by means of which the depth at which the reflection took place can be determined. The determined depth is output by the analysis device as a distance signal which represents the distance of the pulp from the surface to which the measurement light was guided. The warning or stopping device, which is connected to the analysis device 9 in order to receive the distance signal, compares the distance signal to a prescribed minimum distance which is stored in a memory of the warning and/or stopping device. If the comparison yields the result that the distance has reached or fallen below the minimum distance, the warning and/or stopping device emits an acoustic or optical warning signal. Additionally or alternately, it can also act on the examination or treatment instrument 1 in order to stop the examination or treatment; for example, it can stop a drill.

The dental treatment or examination apparatus is controlled by the control unit 13, which is assigned to the white light interferometer and which comprises a control program which causes the white light interferometer to continually undertake depth scans. The control unit 13 can also, as illustrated in FIG. 1, optionally be connected to the warning and/or stopping device 11 and the dental treatment or examination instrument 1. This enables the warning and/or stopping device 11 to emit a stop signal to the control unit 13 when the distance reaches or falls below the minimum distance. The control unit 13 then effects the stopping of the dental treatment or examination instrument 1.

An exemplary embodiment of the dental treatment or examination instrument 1 in accordance with FIG. 1 is illustrated in detail in FIG. 2. As already mentioned previously, it is designed as a dental drill. Said drill comprises a handle 3, a drill head 6 and a drill tool 37 which is arranged on the drill head 6 and is powered by an electric motor (not illustrated).

FIG. 2 also illustrates a tooth 39, in which the pulp 41, the dentin 43 and the enamel 45 can be seen. The drill tool 37 is used to drill into enamel 45 and dentin 39 in order to remove caries, for example. In the process, the drill tool 37 should not reach the sensitive pulp 41. Hence, the dental treatment or examination apparatus according to the invention described with reference to FIG. 1 emits a warning signal and/or stops the drill tool 37 when the distance d between the surface 47 of the bore and the pulp 41 reaches a minimum distance or falls below the latter.

In order to guide the measurement radiation to the tooth 39, the optical waveguide 25 of the measurement beam branch 19 is guided through the handpiece and the drill tool 37 to the distal end of the drill tool 37, which simultaneously forms the distal end 5 of the dental treatment or examination instrument 1. The distal end 31 of the optical fiber 25 is located in the distal end of the drill tool 37. If need be, it can also be recessed with respect to the distal end of the drill tool 37 in order to reduce the operational demands on the distal fiber end 31 during the drilling process.

The optical waveguide 25 is guided through the rotational axis of the drill tool 37 in the latter. For this purpose, the drill tool is either designed to be hollow along its rotational axis in such a fashion that the drill tool 37 can rotate around the optical fiber 25, or the optical fiber 25 comprises a distal end piece which is coupled to the rest of the optical fiber by means of a rotatable coupling. In the latter case, the distal end piece of the optical fiber can co-rotate with the drill tool 37.

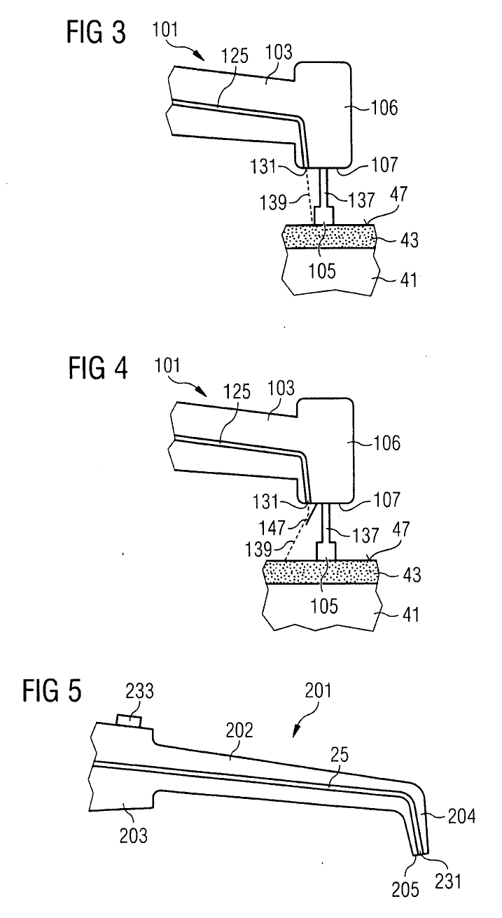

An alternative embodiment variant of the drill in accordance with FIG. 2 is illustrated in FIG. 3. The figure also shows a section of the tooth, in which the dentin 43 and the pulp 41 can be seen.

The drill 101 in accordance with FIG. 3, like the drill 1 in accordance with FIG. 2, has a handpiece 103, with a drill tool 137 arranged at the end of the latter. In contrast to the drill 1 in accordance with FIG. 2, the optical fiber 125 in the present embodiment variant is not guided through the drill tool 137, but rather it ends at the underside of the drill head 106. The arrangement of the distal fiber end 131 in the drill head 106 is selected such that the emerging measurement radiation is incident on the surface 47 at the location of the distal end of the drill tool 137. This is illustrated in FIG. 3 by the dashed line 139. The variant of the drill 101 described with reference to FIG. 3 has a significantly simpler mechanical design than the variant described with reference to FIG. 2. Furthermore, it is possible to continue to use standard drill tools.

A further alternative embodiment variant of the drill is illustrated in FIG. 4. This embodiment variant is very similar to the embodiment variant in accordance with FIG. 3. Elements corresponding to the elements of the drill 101 in accordance with FIG. 3 are referred to in FIG. 4 by the same reference symbols as in FIG. 3, and are not described again in order to avoid repetition.

The drill 101 illustrated in FIG. 4 differs from the drill illustrated in FIG. 3 only by the provision of a scan apparatus 147 on the underside 107 of the drill head 106, by means of which scan apparatus the incidence location of the beam 139 on the surface 47 can be offset laterally. The scan device 147 can be implemented in the form of one or more galvanometer mirrors for example, the orientation of which being able to be set by electric signals. Using the scan apparatus 147, it is possible to carry out depth scans in a lateral region of the surface 47, which makes tomographic records of a tooth volume possible and thus also affords the possibility of determining the lateral course of the boundary surface between the pulp 41 and the dentin 43.

Instead of the galvanometer mirrors mentioned by way of example, the scan device can also be implemented by a displacement device, by means of which the distal fiber end 131 can be displaced along the underside 107 of the drill head 106 in at least one direction, but preferably in two directions.

An alternative exemplary embodiment of the dental treatment or examination instrument in accordance with FIG. 1 is illustrated in FIG. 5. The instrument illustrated is only an examination instrument 201, the sole object of which being to determine the distance of the pulp from the current surface, that is to say the surface of the tooth or a bore. The examination instrument 201 comprises a handpiece 203 which has a needle-shaped protrusion 202 with an angled section 204. The shape of the examination instrument 201 therefore substantially corresponds to that of a dental probe.

The optical waveguide 25 of the measurement branch of the white light interferometer 7 in accordance with FIG. 1 is guided through the handpiece 203 and the needle-shaped protrusion 202 to the distal end 205 of the needle-shaped protrusion 202. The optical fiber 225 has a distal fiber end 231, which corresponds to the distal end 205 of the needle-shaped protrusion 202.

In order to examine the tooth, the distal end 205 of the protrusion 202, with the distal fiber end 231 arranged therein, is guided to that location of the tooth at which the distance of the pulp from the tooth surface is intended to be determined. The handpiece 203 furthermore has an actuating button 233, which is connected to the control unit 13 and by means of which the control unit 13 can be prompted to emit an actuating signal to the white light interferometer 7, which actuates a white light interferometric measurement of the distance of the pulp from the surface against which the distal end 205 is placed. If the result of the measurement is that the distance has reached or fallen below the minimum distance, an optical or acoustic warning signal is emitted.

The dental treatment or examination apparatus according to the invention makes it possible to avoid inadvertent opening of the pulp by means of one of the methods according to the invention. In the process, the treatment instrument can be stopped, or a warning signal can be emitted which should prompt the operating staff to shut off the treatment instrument.

What is claimed is:

1. A dental treatment or examination apparatus, comprising:
a white light interferometer (7) having a measurement beam branch (19), a reference beam branch (17), an emitter (31, 131, 231) for emitting measurement radiation toward a tooth to be treated or examined, a receiver (31, 131, 231) for receiving measurement radiation reflected by the tooth to be treated or examined, superposition equipment (21) for superposing reference radiation and reflected measurement radiation, and a detector (23) for detecting the superposed radiation and for generating an interferometric signal representing the superposed radiation;
a dental treatment or examination instrument (1, 101, 201) having a distal end (5, 105, 205) in which the emitter (31, 131, 231) and the receiver (31, 131, 231) are arranged, the distal end (5, 105, 205) being designed to be brought close to the tooth of a patient to be treated or examined;
a control unit (13) assigned to the white light interferometer (7) with a control program that causes the white light interferometer (7) to carry out depth scans of the tooth;
an analysis device (9) connected to the detector (23) for receiving the interferometric signal, the analysis device (9) being operative to determine a distance of the pulp of the tooth to be treated or examined from a current surface of the tooth and to output a distance signal representing the distance; and
a warning or stopping device (11) connected to the analysis device (9) for receiving the distance and being designed to emit a warning signal or stop the dental treatment or examination instrument (1, 101, 201) when the distance reaches or falls below a predetermined minimum distance.

2. The apparatus of claim 1, wherein the measurement beam branch (19) comprises an optical fiber (25) with a distal fiber end (31, 131, 231) arranged in the distal end (5, 105, 205) of the dental treatment or examination instrument (1, 101, 201), the emitter and the receiver being formed by the distal fiber end (31, 131, 231).

3. The apparatus of claim 2, wherein the dental treatment instrument (1, 101) is a drill with a drill tool (37, 137) having a distal drill tool end (37, 137), the distal fiber end (31, 131) being arranged in or near the distal drill tool end (5, 105).

4. The apparatus of claim 3, wherein the optical fiber (25) is arranged along the rotational axis of the drill tool (37) of the drill.

5. The apparatus of claim 3, wherein the optical fiber (25) is arranged outside of the drill tool (137) of the drill (101) such that the distal fiber end (131) is imaged at a location of the distal drill tool end (105).

6. The dental apparatus of claim 1, wherein the control unit (13) has a control program that causes the white light interferometer (7) to continually carry out depth scans of the tooth.

7. The dental apparatus of claim 1, further comprises an actuating element (233) to be operated by treatment or examination staff, the actuating element (233) being connected to the control unit (13) for emitting an actuating signal actuating a depth scan.

8. The dental apparatus of claim 1, wherein the measurement beam branch (19) comprises a scan apparatus (147) for laterally offsetting the measurement beam on the tooth to be treated or examined.

9. A method for controlling a dental treatment or examination instrument (1, 101, 201), the method comprising:
undertaking a depth scan of a treated or examined tooth region during a dental treatment or a dental examination by white light interferometry;
determining a distance of the treated or examined tooth region from pulp of the tooth based on the depth scan; and
stopping the dental treatment or examination instrument (1, 101, 201) if the distance reaches or falls below a predetermined minimum distance.

10. The method of claim 9, further comprising carrying out a lateral scan of the treated or examined tooth region in addition to the depth scan.

11. The method of claim 10, further comprising undertaking a depth scan at every lateral point of the lateral scan.

12. The method of claim 9, in which depth scans are undertaken continually.

13. The method of claim 9, further comprising manually actuating an actuating apparatus (233) for initiating the depth scan.

14. The method of claim 9, wherein the step of undertaking a depth scan comprises measuring a depth range of 1 to 3 mm.

15. A method for monitoring a dental treatment or examination instrument (1, 101, 201), the method comprising:
undertaking a depth scan of a treated or examined tooth region during a dental treatment or the dental examination by white light interferometry;
determining a distance of the treated or examined tooth region from pulp of the tooth based on the depth scan; and
emitting a warning signal if the distance reaches or falls below a predetermined minimum distance.

16. The method of claim 15, further comprising carrying out a lateral scan of the treated or examined tooth region in addition to the depth scan.

17. The method of claim 16, further comprising undertaking a depth scan at every lateral point of the lateral scan.

18. The method of claim 15, in which depth scans are undertaken continually.

19. The method of claim 15, further comprising manually actuating an actuating apparatus (233) for initiating the depth scan.

20. The method of claim 15, wherein the step of undertaking a depth scan comprises measuring a depth range of 1 to 3 mm.
